(19) United States
(12) Patent Application Publication
(10) Pub. No.: US 2018/0352801 A1
(43) Pub. Date: Dec. 13, 2018

(54) ANIMAL TRAP

(71) Applicant: IIdiko Kovacs, Subotica (RS)

(72) Inventor: Istvan Laszlo VEBER, Subotica (RS)

(21) Appl. No.: 15/524,437

(22) PCT Filed: Nov. 9, 2015
(86) PCT No.: PCT/EP2015/002237

§ 371 Date: May 10, 2017

(30) Foreign Application Priority Data
Nov. 10, 2014 (DE) 10 2014 016 514.0

(51) Int. Cl. A01M 23/08; A01M 23/38; A01M 23/10

(52) U.S. Cl. CPC A01M 23/08; A01M 23/10; A01M 23/38

(57) ABSTRACT

The invention refers to an animal trap, in particular a rat or mouse trap, comprising a catching device (M2) with a one-way segment and at least one killing device (M3, M6), in which a caught animal (T) can be killed, and that has an outlet area positioned downstream of a killing device through which the animal can be released from the animal trap.

### CROSS REFERENCE TO RELATED APPLICATIONS

This application is the US-national stage of PCT application PCT/EP2015/002237 filed 9 Nov. 2015 and claiming the priority of German patent application 102014016514.0 itself filed 10 Nov. 2014.

### FIELD OF THE INVENTION

The invention refers to an animal trap, in particular a rat or mouse trap, comprising a catching device with a one-way segment and a killing device in which a caught animal can be killed. The invention also refers to a method of operating a small animal trap.

Numerous trap designs are known to counteract the spread of small animals, in particular rodent pests and here in particular rats and mice. The classic traps keep the animals caught alive or dead in different containers so that many traps are no longer functional after catching an animal or a restricted number of animals. Traps of this kind therefore require maintenance because they must be checked frequently. Furthermore, traps of this kind raise hygiene concerns. In particular, risks to humans from infection exist, for example from bite injuries from animals that are still alive.

Controlling animals, such as rats and mice, with poisons is also known, associated with the disadvantage that the poisons used are spread in the environment by poisonous substances being absorbed by other animal species, such as dogs, cats and birds of prey, also causing their deaths. A further fact, which is no less dangerous, is that the poisonous substances enter effluent water from which they can be removed in sewage treatment plants only at great technical, chemical and human effort.

In a large number of cases to be considered, the time factor and the distance between the traps play an important role: the time required and the distance to be covered by service staff for every individual animal after ascertaining that an animal has been caught to the time of removing the caught animal is associated with considerable danger of infection and aversion. Furthermore, the methods known so far do not comply with animal protection law.

Numerous suggestions for animal traps designed to kill a caught animal address the killing of the animals but not the disposal of the animal corpses that continue to represent an enormous risk of spreading disease. The maintenance of the trap function after an animal has been killed is similarly not addressed.

For example, DE 20 2012 005 420 shows that the caught animal is killed by a spring-operated hammer. Only a single animal is killed here that must then be manually disposed of, and usually the spring also needs to be re-tensioned manually. This does not represent a contemporary, economical or hygienic solution.

The hygienic aspects of the traps known so far are not compatible with animal protection laws. In order to prevent a spread of disease and the enormous number of parasites caused by the killing and decomposition of the caught animals, traps are to be used primarily according to hygiene guidelines that catch animals alive. In order to reduce the spread of a disease caused by the decomposing animals and to restrict the odor nuisance in the vicinity of the killed animals, these killing traps or containers must be checked at short regular intervals, and emptied. The methods known so far do not permit these disadvantages to be avoided.

One disadvantage of living and killing traps is that the traps must be monitored around the clock, emptied and the areas surrounding the trap disinfected or decontaminated. The drying out of excrements infested with parasites causes the pests to be widely distributed through air movements, thereby increasing the danger of spreading infection and parasites.

In individual cases the animals are caught and killed individually. The traps must be emptied every time an animal is caught. A regular monitoring of the traps is necessary.

There are multiple traps in which the animals are killed mechanically. With this type of trap, problems arise concerning decay-related odor nuisance and the spread of the bacteria and virus contamination caused by the decay. To avoid nuisances of this nature, some inventions suggest cooling or deep cooling of the animal corpses that in its turn requires great technical and material effort as well as energy. Traps of this type can also only take a restricted number of animals, they raise hygiene concerns and are accordingly complex.

Particularly in accessible sewers, rats are usually killed, for example, by laying out poisoned baits with a delay effect so that they cannot be marked by other rats to stop other rats from eating them. Detailed reference has been made to these and similar disadvantages of the known traps and the use of poison in numerous publications. Before rats trust a bait, they visit and inspect it several times.

Nevertheless, the spread of the pests in municipal sewers is controlled in a most unsatisfactory manner by the use of poison. In particular, the larger sewers designed to deal with large quantities of sewage, convey large quantities of water when it rains heavily with a particularly strong current. This current takes the poisonous baits with it and straight to the sewage treatment plants. The poisons therefore get into the sewage both indirectly by the pests eating them and directly by way of their corpses. These poisonous substances must be eliminated from the sewage by the sewage treatment plants at great technical and chemical effort and ultimately higher costs before the cleaned sewage can be passed into the rivers. Sewage treatment plants satisfying these environmental standards are expensive and are not used in numerous parts of the globe for cost reasons. These poisons therefore enter the water cycle unfiltered where they damage other creatures.

Some rodent pests are already immune to the so far known active substances in the poisons used so that combating these species with chemical means proves to be completely useless.

### OBJECT OF THE INVENTION

The invention is based on the task of providing killing traps that are suitable for as many habitats of the animals as possible, meet the requirements of animal protection laws and the highest hygiene standards, are ecologically acceptable, technically reliable, easy to service and economical whilst avoiding the inadequacies of existing catching methods and traps. In particular, after having killed an animal in accordance with animal protection requirements, a trap should be immediately ready to catch a further animal. Furthermore, a preferred task is to provide a trap that has very low energy requirements.

### SUMMARY OF THE INVENTION

The task is solved with an animal trap, in particular a rat or mouse trap of the type mentioned at the beginning that has an outlet area following a killing device through which the animal can be released from the trap. As an essential part of the invention, the trap is designed such that an animal leaves the killing device or the trap again, in particular in a killed or dying state, so that a trap according to the invention is ready for use again immediately after an animal has been killed.

In one operating method of a trap this can be achieved, for example, by the animal being transported automatically toward the outlet area of the trap solely or at least partly through gravitational force on the still alive or already killed or dying animal, so that it leaves the trap that is then ready for operation again.

According to the invention, the catching device can be arranged higher than an access device, whereby the access device comprises a climbing element or is formed solely by a rope or a slope or a tube through which the animal enters the catching device.

The animal therefore climbs up a certain height above the start of the access device, receiving a potential energy that the trap then uses to convey the animal further or to convey it out or bring about the killing or to trigger other functions of the trap.

The trap according to the invention can also comprise a guide device that has an at least partially enclosed space with at least one entrance, in particular one-way entrance and an exit, whereby the exit is such that it guides an animal to the access device, in particular the access device ends in the exit. In the example embodiment, this guide device can be a box with at least one entrance that is near to a side wall of the box so that the guide device can be set up along a room wall of a property. This takes the fact into consideration that rats or mice, for example, typically run along walls of this type and therefore, through their own behavior, reach the entrance to a guide device of this nature and run inside it, and preferably cannot run out of the entrance again due to the one-way function realized inside it, for example due to blocking flaps or spikes.

The invention can provide for the top of the guide device being open by preference, and in particular having an exit pointing upward through which an animal can leave the guide device again. According to the invention, the above described access device is preferably to protrude into the exit, for example a climbing rope or tube or any other climbing element that forms the access to the catching device. An animal in the guide device is therefore guided more easily to the access device, particularly if this is done additionally by baiting, for example scent from the direction of access device. This is particularly most possible if the climbing element forms a passage.

The exit of the guide device can be formed by a funnel-like element that tapers down. The climbing element of the access device can reach into the funnel-like element or generally into the exit. The climbing element of the access device is preferably jointed at the end facing the catching device, in particular connected in a jointed manner with the catching device or with a modular support to be described later, so that the end facing the guide device, or the lower end, can be positioned flexibly.

The invention can provide for the killing device to be executed separately or to be arranged in the catching device, in particular downstream of or at the end of the one-way segment or to be formed at least by one electrically conductive electrode, preferably at least one electrically conductive comb element, or to at least comprise such. The animal can therefore pass by at least one such electrode, preferably a comb element, in the catching device, whereby the one comb element at least glides through the fur by preference and can come into direct contact, i.e. with the comb tips, with the skin. The animal can be killed in compliance with animal protection law by way of electric shock, particularly with the use of comb-shaped electrodes.

An electrical alternating voltage with, for example, varying amplitude and/or varying frequency, can be used in the at least one electrode, the reference potential of which is formed by the free wheel, for example, or at least a further electrode that can touch the animal in order to bring the animal's heart out of tact without the animal having to suffer burns caused by the electricity.

The alternating voltage referred to can be generated between at least two electrodes/comb elements of the killing device, whereby every or at least two of the electrodes/comb elements can have different alternating voltages applied to them. For example, an alternating voltage with altering amplitude but constant frequency can be applied to one electrode/comb element and an alternating voltage with constant amplitude and altering frequency to another electrode/comb element.

The animal can therefore be further conveyed in the trap or from the trap by the force of gravity.

A killing device can also be placed behind the catching device and its one-way segment in accordance with the following description, i.e. not be integrated in it but be arranged separately, for example with the same previously described functions and/or electrode structures.

Irrespective of the position of the killing device, the invention can preferably provide for the one-way segment of the catching device to comprise a free wheel with horizontal rotational axis, whereby the free wheel runs freely toward the one-way segment, and for a drop device to be arranged downstream of the catching device into which the animal falls from the free wheel, particularly toward the outlet area.

It can be that the access device or its climbing element ends in the catching device, so that the animal reaches it when climbing up. A one-way function can be realized by way of flaps and/or protruding spikes that give way toward movement of the animal but which can block the way if the animal reverses, thereby setting a direction of movement of the animal in the catching device.

The one-way direction can also be defined only by the free running direction of the free wheel. The free wheel can, for example, have an outside surface or wheel surface with recesses or holes to provide grip for the claws of an animal. The surface can also be roughened or gritted. The free wheel can be made of metal by preference and form an electrode, particularly if a killing device with electrodes, preferably comb electrodes, is in the catching device.

The animal reaches the free wheel and can climb it because the free wheel is prevented from turning counter to the direction of movement. Having arrived at the highest point of the free wheel, the animal's center of gravity moves to behind the rotational axis and causes the free wheel to turn in the free running direction so that the animal is automatically conveyed and either reaches the killing device that is already in the catching device or falls down from the catching device and is conveyed to a killing device, preferably supported solely or at least partially by the force of gravity.

The invention can provide for the movement of the animal on the free wheel to be supported. For example, the rotation of the free wheel can be supported by a motor in the free-wheeling direction and the motoric rotation can start as soon as a sensor detects the presence of an animal. Alternatively or collectively, the invention can provide for an optical or acoustic signal in the catching device behind the animal to scare the animal and therefore to automatically push it along. A signal can be given as soon as a sensor has determined that the animal in the catching device has passed the signal transmitter, i.e. it is then behind the animal.

The above mentioned catching device that the animal reaches after the one-way segment can preferably be formed by a vertically extended passage, particularly a tube. A round cross-section is not essential here. The terms “passage”/“tube” comprise all cross-sectional forms, preferably rectangular or round. Depending on the arrangement of the killing device, the tube can selectively convey the animal, which is still alive, already dead or dying, to a further treatment station in the trap. For example, the tube can combine the catching device with the outlet area or the killing device and/or a packaging device still to be described.

The invention can provide for the inner wall area of the tube of the drop device having at least one projection winding spirally around the central tube axis that has in particular a triangular cross section perpendicular to the direction of elongation. This causes the animal to rotate around the tube axis when it drops through the tube.

One execution of the invention can provide for a killing device to follow the drop device in drop direction, in particular for the tube to end in a killing device or for the killing device to form part of the drop device, particularly if a killing device is not already contained in the catching device. The killing device can also be formed by or in a part of the tube, in particular an end area of the tube or enclosed by it.

The killing device can, particularly instead of the at least one electrically conductive electrode, preferably comb electrode, or in addition to it, be formed by knife blades positioned diagonally to the direction of drop, in particular diagonally to the longitudinal extension of the tube. The knife blades can protrude into the tube to different extents and in particular the depth of protrusion can increase in the longitudinal direction of a knife blade. The falling animal is preferably conveyed such as to rotate into the sphere of influence of the knife blades and is killed unless this has already happened by arrangement of a killing device in the catching device. In this respect several killing devices can also be provided in the trap that in particular kill an animal using different methods, preferably electrically in the catching device or at the end of the catching device by knife blades.

A killing device can alternatively be arranged upstream of or behind the catching device, possibly also forming an integral part of the drop device or of the catching device.

Even if an animal is already killed in the catching device, for example by means of the above described electric shock, the use of such knife blades at the end of the drop device and in particular at the end of the above mentioned tube may be advantageous because the resultant production of blood entices rodent pests with a cannibalistic propensity, such as rats.

The invention can furthermore provide for a packaging device following the drop device, in particular the above described tube and/or the killing device, in which an animal can be packaged in or with at least one packaging element, in particular in a plastic tube. The packaging is preferably air-tight.

This arrangement is preferably to be provided if a killing device, such as the above described combs, is already located in the catching device or at least between catching device and packaging device, in particular that comprises at least one, preferably at least two, electrically conductive electrode/s/comb/s with the above described function.

A plastic tube can already be prepared and the animal, following gravity-induced transportation to the packaging device, sealed or stuck in it. An animal can also be contained between two adhesive strips with the adhesive sides facing each other. For this purpose, the adhesive strips can be advanced toward the animal from a stock of them by way of a roller system.

One roller, which has a flexible surface between its axial ends, can enclose areas of the animal corpse and press together the edges of the adhesive strips with its axial ends. This roller can be arranged so as to move on a slide, and in particular have a pre-tensioned spring force in one direction, preferably toward a preferably stationary counter-roller.

The invention can provide for the animal to be enclosed in the packaging with inert gas and/or the animal and the packaging as well as the inside of the device to be disinfected by the addition of chemicals and/or UV radiation. Accordingly, a packaging device can have an inert gas dispensing device and/or a UV illumination device (in particular UVC) or a device to release a disinfectant.

The packaging device may comprise a separating device to cut off the at least one packaging element, for example a plastic tube or two connected adhesive strips with the enclosed animal. The separating device comprises a sharp, preferably V-shaped cutter that has two blades facing outward along the V-sides and is controlled such that it penetrates preferably the center of the at least one packaging element and is pushed further into the packaging element by way of axial movement along its longitudinal edge, thereby cutting it off toward inside to outside.

A further development can provide for the trap to comprise an air-tight hood or bell that is open at the bottom in which at least the catching device and/or parts of the trap are arranged that have an electrical supply or mode of operation. This enables at least the catching device or the above mentioned parts to be kept dry if the trap is located in an area of rising water level because the water cannot rise above the lower opening of the hood or bell.

The bottom end of the drop device, in particular the drop tube, can be sealable if the water level rises, for example by way of a sealed lid at the bottom end that closes by way of a floater that moves as a result of the water level, thereby closing the drop device. An arrangement of this type comprising floater and sealed lid can generally be arranged in the outlet area of the trap even if this area is not formed by the end of the drop device.

A particular advantageous further development can provide for the animal trap of the invention to be formed as a system in which the different devices, in particular catching device, access device, drop device, killing device, packaging device and possibly sealing device, are each formed by at least one modular element and the modular elements forming the different devices can be optionally combined with each other.

For this purpose the modular elements can have mechanical and/or electrical interfaces using which the modules can be interconnected.

It may be the case that a catching device is formed by different modular elements, for example elements with or without killing device. Due to the modularity, the user can also decide, for example, whether he wishes to assemble a trap from the system with or without packaging device by optionally installing the corresponding modular element or not. A modular support can be used to assemble the modules on it, for example a modular base plate.

If the packaging device is not used—either as module or in a finished trap product comprising several devices—the invention can provide for the killed animal to exit from the outlet area, for example the bottom end of the drop device, in particular the drop tube. For example, this solution can be used in a sewer in which the killed animals are transported away by the sewage water current to the sewage treatment plant.

A collecting box for the packaged animals can be preferably provided at the outlet area of the trap following a packaging device in which the animals are kept ready for collection. Here too, a disinfecting device can be arranged in the collection container, for example UV light radiation.

The caught animals can be recorded preferably without constant electronic monitoring.

The invention can be an electromechanical, preferably modular, animal trap, in particular as permanent baiting trap. It serves to regulate the population of animals, contain health hazards to other living beings, whereby electrodes, preferably supplied with high voltage, such as the above mentioned comb elements, may be arranged, for example, in the catching device or in a killing device positioned downstream of it. The small animal trap according to the invention provides for the fast, poison-free killing and elimination of a large number of animals.

The invention primarily uses the animal's own force, avoiding the conversion of energy. The animal climbing up produces a high potential energy that leads to its own certain and quick death or at least to the transportation in the trap or to the triggering of trap functions.

To increase the through-put of the animals to be eliminated, the components of the device are preferably operated from an electrical energy source such as batteries or storage batteries, in stationary cases from the electricity grid.

The invention with the specified features offers the advantage of facilitating uncritical control in terms of the environment and animal protection without impairing the requirements of animal protection. It requires little work due to the extremely short killing times, providing the possibility to kill and dispose of a large number of pests. It also offers the advantage of protecting the user by exemplary safety precautions in terms of servicing the system, filling the packaging device or module with adhesive rolls, disinfectants and bait—something that can also be done by laymen without problem or danger. The electrical high voltage parts are insulated by safety switches so that they be positioned safely by the user.

The invention permits a large number of animals to be killed in the shortest space of time. It can provide for the charge levels of all connected energy storage (storage batteries) to be periodically inspected individually. If the charge voltage of an energy storage unit falls below a critical level, it is switched off, and a status entry is made, possibly a status protocol that is given priority treatment when the data are transmitted to the monitoring point.

Depending on requirements, the entry of animals into the trap can be reported directly to the monitoring point together with all relevant data and identification of the system. Alternatively, for the statistical recording of the efficiency of the small animal trap concerned, the process is stored with the requisite data, read out and analyzed.

One advantage is that a weight-dependent distinction between young animals and adult animals is not necessary.

The electrical operation of the in particular modular system preferably consumes no electrical energy in resting state (as would be the case for stand-by operation). A redundant energy consumption is guaranteed by using ultramodern components. Electrical energy is preferably consumed only once an animal has entered the access device or catching device, for example by means of a passive working contact that starts the program run of the respective device, preferably of the module, and ends at the end of the operating program.

In a preferred further development, an automatic disinfection, and in the case of higher hygiene standards, the sterilization of the system, can take place by the UVC radiation used, for example, or by using sterilizing agents. To increase the attractiveness of the trap to the animals, the disinfectant can have aromatic scents with baiting effect. The possibility of disinfection of this kind can be provided for in every one of the possible devices or modules, for example by a respective disinfection unit, for example with UVC lamp. The packaging of the killed animals means that the nauseous disposal of the corpses is no longer necessary and no additional pathogens are released into the environment but are contained with the corpse.

The quantity of caught and killed animals can be recorded by means of a start contact in the catching device and can preferably continue to be compared with the existing quantity of packaging material, for example the length of adhesive strip. Depending on the quantity caught and catching frequency, a reliable prediction can be made on the smooth operation of the packaging module.

Depending on requirements, a killed animal can drop into a catch box unpackaged or hygienically packaged, or drop directly into the sewer (preferably unpackaged). The quantity caught can be checked by determining the weight of the catch box or by the quantitative recording of the additions to it.

One preferred use of the animal trap is in the dry area.

According to the invention, a dry area refers to environments that are located in closed structures or outdoors. In addition to low maintenance, the hygienic elimination of the caught animals is an essential requirement. The energy sources for traps in accordance with the invention in this application can be electricity mains connections, storage batteries, batteries, solar-driven or other electricity sources.

According to the invention, the killed animals are packaged hygienically in an air-tight manner in the dry area depending on requirements. As a result of the preferred oxygen vacuum, the decomposition-related spread of bacteria and odor nuisance are stopped completely. Accordingly, it is not necessary to examine the systems at short intervals. The invention can provide for an automatic status report with catch statistics according to the requirements of the trap setter that can be transmitted to a monitoring point. Remote monitoring of this nature drastically reduces the maintenance work and costs.

In a further development to optimize packaging materials, the invention can also provide for the animals to be packaged to be individually measured, so that the consumption of the packaging material can be reduced, a large number of caught animals packaged and the maintenance interval increased.

In developing the modular traps, special attention has been paid to complying with the provisions of the animal protection laws. The different voltage levels of the high voltages and the different areas of influence of the preferably comb-like high voltage electrodes used guarantee a fast and painless death of the caught animals.

The contamination of the environment is reduced considerably due to the fact that the animals are eliminated without delay after entering the traps and are isolated from the environment by the hermetically sealed packaging. Depending on requirements, the trap can be disinfected automatically at defined intervals using UV radiation or disinfectant.

The animals are eliminated completely without the use of poison so that the spread of poisonous substances in the environment can be avoided completely. These are safety aspects of relevance to small children, pets, birds of prey and other livestock that could come into contact with the poisonous substances or the poisoned rodent pests.

Contrary to the applicable hygiene guidelines, the animals in the dry area are killed within a very short space of time, preferably packaged hygienically, and must no longer be kept in a cage alive, waiting for release by the service staff.

In order to increase the throughput of the caught animals, the invention can provide for placing the animals in the catching device under stress—as already explained—by the emission of a visual light signal, for example, and/or by the emission of sounds using an acoustic signal transmitter, so that the animal is forced to escape forward and move further into the trap.

The invention can provide for the animals to be baited with acoustic signals, in particular in the ultrasound area from the wider environment because their hearing organs are attracted by enticement signals.

Alternatively or cumulatively, the organs of smell of the animal to be baited can be animated to seek out the trap with the aid of aromatic scents. Scented bait, in particular non-consuming scented bait, can be arranged in the catching device for example. Provision can be made for a ventilation device, for example a fan, to distribute the scented bait, for example from out of the catching device toward the access device and/or through it (if formed as a climbing tube, for example) into a guide device, for example.

In the preferred application, the trap according to the invention can also be used in the wet area.

Wet area refers to spacious, accessible effluent water sewers in which a predominantly moist climate prevails where predominantly different animals, particularly different species of rats, are to be found, serving them both as traffic area and as habitat.

No hygienic requirements need to met in this environment. However, the devices/modules of the preferably modular traps must be able to withstand the particularly rough conditions of an extremely moist environment, as well as the extreme currents of the effluent water in the case of flooding, satisfy the ecological aspects of poison-free killing, comply with the provisions of animal protection laws, be largely maintenance-free and economical to run.

This is an extremely adverse environment for technical systems.

One particularly strong disturbance in this environment is the fact that heavy rain or other reasons can lead to the flooding of the sewers, whereby high flow speeds of effluent, as well as floating objects can greatly damage the trap mechanics.

Embodiments of the trap in accordance with the invention can take these conditions into consideration.

The invention can provide here for the killing of the animals in the wet area not to take place in the catching device or module—unlike with the dry device. The animals in the wet area without additional energy source leave the access device alive and directly reach the drop device, for example the tube with the spiral coiled projection on the inner tube wall, the so-called turned tube. A possible dying process will be explained in the following.

The trap can comprise an electronic controller. This electronic controller and storage unit has the task of recording data, for example all sensor, catch- and trap-relevant data (catch data), to store it, for example a temporal and quantitative assignment of the incidents in accordance with the program run of all traps assembled by the different combination of the modules, depending on the control program used, the logging of existing freely programmed target values with the incorporation of the sensor data. A further task is to control all actors such as drive instructions, as for the disinfecting process, emergency exit opening in accordance with defined tasks, recording all catch- and trap-relevant data (catch data), to store it and to provide these data for reading out, further processing, and to transmit them either to the monitoring point by telecommunication means (for example by radio signals, land-line connections, mobile radio networks GPS, GMX, etc. or other paths) or to make them accessible directly on site on a trap display or in a contact-free manner. All catch data can be collected in the controller that are sent to the monitoring point using telecommunication means, or read out during routine service work.

According to the invention, it is sufficient to record the data by the sensors used; a temporal and quantitative assignment of the accesses and incidents is sufficient for the technical processing of data of any type. This statistically supported optimization primarily extends to determining the most favorable installation site of the systems, to determining their optimum capacity (through-put), and to their technical condition.

It can similarly be possible to remotely request the system status.

The invention can provide for a status protocol to be prepared of the general technical status, such as collected catch data with date and time, catch readiness, the existing quantity of adhesive rolls, and charge level of the energy sources. The data are stored and can be readout in a contact-free manner at any time with the assistance of the transmitter depending on the requirements of the trap setter. They can also be sent using means of telecommunications, so that the servicing and maintenance of the systems can be planned and are economical. A statistical analysis of the device efficiency can be optimized in business terms, leading to a reduction in the necessary checks and servicing intervals.

All stored files and regular status reports can be set from the wet area of the accessible sewers or from other buildings.

As already mentioned, the invention is preferably formed in a modular manner. “Modular” is understood to mean the structuring of an entire trap with the assistance of individual assemblies (modules) that are interconnected in different combinations to satisfy the tasks of the invention for the different operational areas, whereby the assemblies (modules) are only able to satisfy sub-tasks. Modules of this type can be fixed to a support element, for example, so that a support element of this type, for example a plate, and the modules forming the devices fixed on the plate form the trap in its entirety.

The support element may have predetermined assembly positions to which the respective individual modules can be fitted. If an assembly space is not to be fitted with the intended module, a further conveying module or a dummy module can be provided for so that, with the exception of the function of further conveying the animals between the two other modules, it is not responsible for any further treatment of the animal.

An alternative embodiment can provide for freely positioning the modules in relationship to each other on a module support.

Through a combination of the individual electromechanical modules, the invention satisfies the requirements of a multiple permanent-bait small-animal trap adjusted to the different conditions of use for the poison-free killing, fast elimination and hygienic packaging of a large number of rodent pests in a short space of time.

By combining the individual modules to meet the requirements of different conditions of use, many areas can be covered and the modular systems adjusted to suit the special problems. The individual modules satisfy only sub-tasks.

The invention therefore preferably forms a modular, in particular multiple small-animal trap for the killing and fast elimination of animals, in particular rats and mice, without the use of poisonous substances, through the hygienic air-tight packaging of the caught rodent pests in the dry area. In accordance with the invention, the system can be operated in the wet area without additional energy source by suitable adjustment of the modules.

In order to avoid a marking of the hazard source as a warning to other intelligent fellow animals, special attention was paid in the design of the invention to ensuring a particularly fast sequence of events. In the packaging process, the animals drop into the packaging from above, and any death-related emptying of intestine or bladder cannot warn other animals because the excrement of the killed rodent pest is packaged with it in an air-tight manner. In order to restrict the proliferation of germs in the packaging itself, it is suggested that sterilizing agents, such as urea or similar, are packaged with the animal corpse together with an inert gas.

It is known that rodent pests such as rats communicate with each other via ultrasound signals. Already published studies prove that rats in particular transmit their positive feelings to other rats with the assistance of ultrasound signals. The invention can provide for such acoustic communications to be recorded or simulated and for the acoustic communications to be sent through the trap as bait to produce a positive environment with suitable technical means in the ultrasound range.

The animals can be attracted acoustically, particularly in the ultrasound range, over a wide area. The geological and architectural topographies greatly reflect the ultrasound signals, so that even winding hide-outs of the animals can be better reached. Baiting with the above mentioned recordings does not depend on the time of the year; coupling and birthing times have no influence on the efficacy of this type of baiting.

The invention can provide for attraction signals to be stored in a controller unit that, particularly from time to time, are emitted via an ultrasound transmitter, whereby a happy mood is acoustically suggested through the trap, thereby attracting the animals.

Alternatively or cumulatively, the invention can also provide for a scent dispensing unit to be used in the trap that attracts the animals due to the air flowing around the bait, causing the scent to be spread generously. For this purpose, the trap can have a fan through which the outside air is sucked in and in particular is guided to the trap under the pressure of the flow through a bait box. The scented air can then be blown through exit openings in the trap, in the catching device or access device, attracting the animals with the atmosphere enriched by the baited scent.

As a result of the aromatic baiting in accordance with the invention the animal does not reach the bait itself but only smells the scent so that the necessity to replace the bait is completely eliminated. It is therefore referred to as permanent bait trap although the bait can be natural or synthetic aromas.

In the wet area the baiting of the animals can be extended to include an additional bait scent laid out in the wet area. A temporal, in particular periodical, regulation of the bait ventilation can also be provided for.

### BRIEF DESCRIPTION OF THE DRAWING

Examples of embodiments for the wet area parallel to the dry area with and without the packaging of the animals are explained in the following with reference to the drawing in which:

FIG. 1 is a side view partly in section of a modular trap with several modules for use in a wet area;

FIG. 2 is a side view partly in section of a modular trap with several modules for use in a dry area; and

FIG. 3 is a perspective view of a detail of FIG. 2.

### SPECIFIC DESCRIPTION OF THE INVENTION

The traps shown in the drawing are described together with respect to their common features.

Attracted by positive feelings sent by an ultrasound signal transmitter, for example, the animal T is attracted from a distance to the set trap. Once in the vicinity it also smells the bait scent and is drawn to the access device. As far as the invention is concerned, it is irrelevant how animals are attracted. This may not even be necessary.

The animal T first reaches the access device of the module M1 that in a wet area preferably comprises a climbing rope as climbing element 1 that can be provided at the entrance of the catching device that is formed by the module M2.

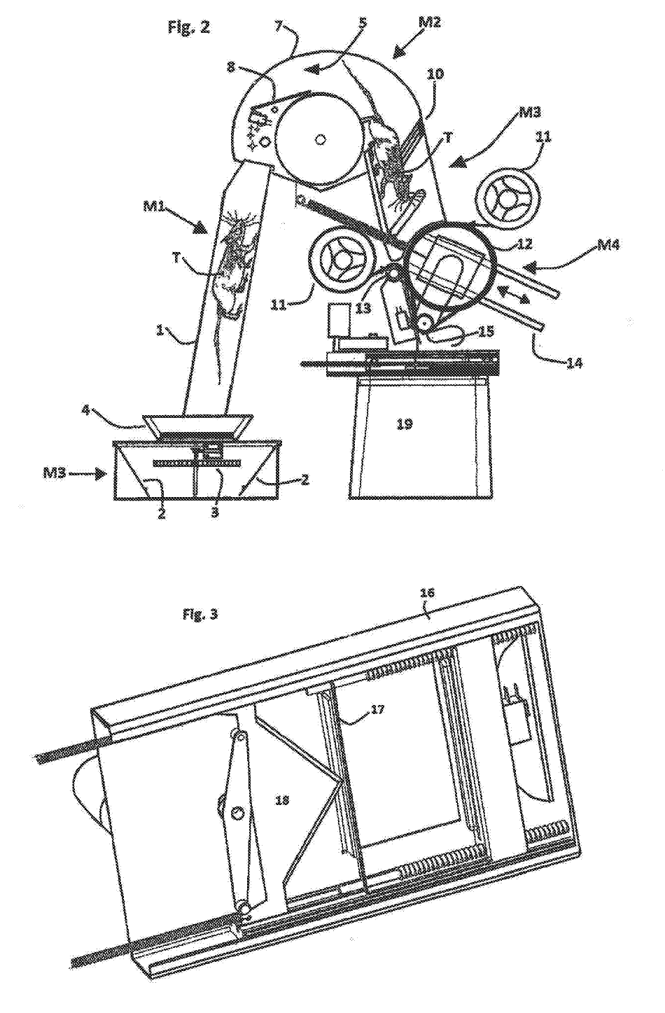

In a dry area (FIG. 2) the climb can be made via a gangplank or a climbing tube or similar as the climbing element 1. The climbing element 1 accordingly forms the upward path to the catching device of the module M2 and can be exchanged or selected depending on the application by virtue of the modularity.

In the dry area, the rodent pest animal T, such as a mouse or rat, prefers to run along walls. So as to facilitate entry to the trap, a guide device as a module M3 is placed directly in their path. On entering the guide device M3 they pass the entrance area of the module M3, for example via symmetrically arranged access openings with wall access blocking bars 2.

In the event of a disturbance to the system, the invention can provide for an emergency-stop activator 3 that triggers the locking of the wall access blocking bars 2, thereby blocking access to further animals. If an animal is in the system during blocking of the access, it can leave the system by jumping through a top escape slit.

The guide device formed as the module M3 has a top funnel-like exit 4 into which the lower end of the climbing element 1 extends. Its top end is connected to a module support preferably in a jointed manner or directly to the catching device of the module M2.

Irrespective of the specific design of the access of the module M1, the animals reach the entrance area of the catching device formed as module M2 at the upper end of the access device and in particular of the climbing element 1.

The animals T enter the catching space 5 via a slip-proof surface of the free wheel 6. The module M2 preferably offers a sufficiently wide surface restricted between the rear wall and a preferable inspection pane and a sufficiently high passageway between the outer slip-proof surface of the free wheel 6 as floor, and the ceiling arch 7.

The animal moves into the catching device M2, for example enticed by the bait scent from a bait scent opening that is provided for as the module M3 in the killing device, into which the animal falls head first after passing the free wheel 6.

The animal T first climbs the free wheel 6 that is locked against reverse travel to reach its particularly slip-free outer surface, whereby due to its body height it lifts the pivotable locking bar 8. The spikes that may be present on the locking bar 8 forming a semi-circle, exercise slight pressure on the neck and back of the animal beneath them and prevent it from reversing from the catching space 5 without injury.

The animal T is therefore forced to continue its path forward. It lifts the locking bar 8 with his body height that actuates a start pulse transmitter 9 that transmits a start pulse to a controller and starts a program sequence stored in the controller.

Following the start pulse of the start pulse transmitter 9, loud acoustic signals are given, for example, via an acoustic shock signal emitter and/or bright light signals outside the animal's field of vision behind him via a visual shock signal light, because it cannot look back due to the predefined one-way direction and takes flight forward in panic over the surface of the free wheel 6, i.e. toward the bait scent of the bait scent outlet opening.

A drive can be provided for that sets the free wheel 6 in motion in the running direction for a predefined period of time. The short rotational pulse of the free wheel 6 pulls the animal T clawed on to it in a forward direction toward the drop device of module M3 that also comprises a killing device.

Accelerated after the shift in weight of the animal over the peak in a forward direction, the free wheel bearing of the free wheel 6 runs free and the animal falls freely into the drop device with killing device of the module M3.

High-voltage combs 10 as electrodes are arranged in the drop or killing device M3, which contain in particular the low frequency, preferably varying, high voltages from a high voltage generator with different frequency, phase displacement and amplitude.

The animal holds on to the preferably electrically conductive free wheel 6 with its claws to which an electrical reference potential can be switched.

In this position, the electrical circuit is closed via the one comb electrode 10 and the other comb electrode 10 with a significantly higher low frequency high voltage through the body of the animal, and the electrically conductive surface of the free wheel 6 via its feet. A low transitional resistance through its feet exists if its feet are wet. Since this cannot be guaranteed in practice, provision is made for at least two comb electrodes 10.

During its drop downward, the animal T automatically passes the comb electrodes 10 so that the comb electrodes 10 on the other side of the body come into contact with the skin, similarly creating a small transitional resistance to its body. The fatal electrical circuit is closed through the comb electrodes 10 that are preferably diagonal to its body, through its heart.

Since the comb electrodes 10 have direct contact with the skin of the caught animal, the animal's fur cannot catch fire and unpleasant burning smells are avoided that could prevent further animals from seeking out the trap.

The comb electrodes 10 are not dirtied by the animals because the comb electrodes 10 glide between the fur of the animal T, thereby coming into direct contact with its skin, permitting a minimum transitional resistance through the body.

In the meantime the power supply of the free wheel drive is stopped and the plastic film drive and an inert gas valve to blow up a packaging bag of the module M4 formed as packaging device triggered if this is provided for in the dry area in accordance with FIG. 2.

In the packaging device M4 the killed animals are packaged between two self-adhesive strips, the adhesive sides of which face each other. The adhesive strips are run off from two rollers 11 that are pivotal in the packaging device.

In order to produce an air-tight packaging, tensioning of the adhesive strips is preferably provided for by braking the mountings of the strip rollers 11 and of the strip rollers 11 themselves. The adhesive strips are conducted via a moveable and preferably spring pretensioned roller 12 mounted on a slide 14 and a counter-roller 13, so that the adhesive sides are brought together and stick together. The animal is packed in an air-tight manner and sealed from the environment between the adhesive strips.

The roller 12 can encompass the animal due to the fact that it has an area with reduced diameter in terms of its axial length and breadth, thereby forming a cavity between the surfaces of the counter-roller 13 and roller 12. The reduced area can have the shape of a hyperbole in the cross section parallel to the rotational axis. Only the axial end areas of the surfaces of roller 11 come into contact with the counter-roller 13 via the adhesive strips enclosed between them.

A mounting of a strip coil 11 can have a pulse emitter to record movement in order to check the existence of the adhesive strips for which the movement pulses are transmitted to a controller, for example to determine the length of adhesive strip spooled off from the sum of the pulses counted.

In order to ensure a reliable and hygienic packaging of the killed animals, the animals that have already been killed land between the rollers 12 and 13 prepared in this way and are enclosed between the adhesive strips that form a sleeve around the animal.

During the adhesive process, inert gas can be applied under pressure from inert gas nozzles to between the adhesive strips in order to fill the inner cavity between the adhesive strips with inert gas before the tight sealing of the adhesive strips.

The end of the adhesive strip tube conveyed between the pressure element and the sealing roller can be sealed by the at least one sealing roller 15 that can exert a mechanical pressure from the outer side of the adhesive strip on the still open packaging, because the adhesive strips brought together here are pressed together over the entire width.

This sealing can be communicated to the controller by means of a closure signal transmitter.

A separating device can be provided for in the module M4 or externally as a separate module in order to separate the plastic tube preferably between two packaged animals and to release the animals packaged in this way individually from the trap.

After reaching a separating position, the controller stops the film drive, and starts a separating device as shown in FIG. 3. The separating device comprises a frame 16 through which the plastic tube is conducted. For the purposes of separation, a stamp element 17 is first pressed against a counter-bearing 18 and the plastic tube conveyed between them tensioned. The cutter 18 is then pushed into the middle of the plastic tube with the tip of its V-shaped blade in the example here and cuts it from the center outward to the edge with an axial movement.

The separated packaging bag with the animal corpse falls into the catch box 19 that in this embodiment forms the outlet area of the trap. So as to avoid any contamination of the system if any of the packagings are damaged, the inside of the catch box is disinfected by way of UVC light and/or chemical agents.

The filled level of the catch box can be checked and the filled volume sent to the controller, thereby avoiding a blockage due to overfill and alerting a monitoring center if necessary.

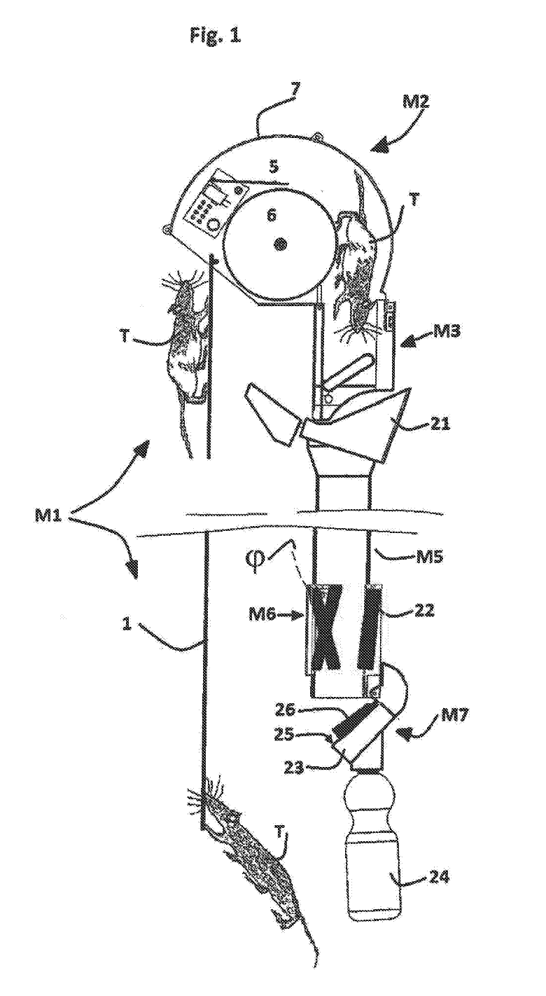

In the wet area, the animal T climbs up to module M2 of the catching device via the climbing element 1 formed as a climbing rope (FIG. 1) and continues its path via the slip-proof outer surface of the free wheel, as already described.

The animal's body lifts the locking bar 8 that sends a start signal to the controller. The free wheel 6 is set into motion in the animal's direction of movement, the high voltage generator applies high voltage to the comb electrodes 10, causing the animal T to be killed in module M3 of the drop device or killing device.

The drop device used in the wet area as module M5 comprises a tube 20 adjusted to the circumference of the animal. The inside of the tube has an elongated spiral with a projection facing inward that makes the dropping animal that may already be dead rotate around its longitudinal axis. According to FIG. 1, module 5 follows a module 3, a killing device.

The tube 20 is connected with the killing device M3 by way of an adapter 21 for the preferably seamless transition, whereby the adapter preferably realizes a jointed connection of both modules M3/M5 for the flexible suspension of the tube 20 to avoid any water-current-related damage.

The length of the tube 20 means that the animal reaches high drop speed via the long drop segment in addition to rotating around its own axis. This also causes an extremely quick death of the animal within the meaning of Article 4 of the Animal Protection Act.

If the trap is to be operated in a wet area with no outside energy supply, the animal is not killed by high voltage in the killing module M3, but it leaves the catching device of module M2 alive through its exit opening into the drop device and falls into tube 20. In the corresponding embodiment, module M3 would therefore not be needed with respect to FIG. 1.

As a result of the vertical drop, the animal prepares for a “soft landing” on its paws as a reflex by stretching out its front and rear paws radially outward relative to its body axis during its fall. It tries to hold on to the inside wall of the tube 20 due to this reflex body position, and support its extremities on the elongated edge of the spiral projection coiled around the tube axis and extending along the inside wall of the tube. The projection reduces the contact surface between the inner tube wall and the falling animal, thereby increasing the drop speed of the caught animal and making it rotate (turn).

This rotation of the animal around its own axis causes deeper cuts from the killing module with blades 22 as module M6 attached to the end of the tube that lead to the faster killing and bleeding of the animal to death. It is not possible for the animal to support itself on the spiral projection preferably facing downward and inclined inward, so that it cannot brake. In addition to the possibility of attaching a killing module, as here M6 at the end of the tube, an embodiment can also be provided in that the drop device as module M5 directly also has a killing device as an integral part, so that in this case the killing device does not form a separate module.

In the case of a separate module, the killing device as module M6 can have a tubular casing, the inside of which comprises sharp blades 22 attached to the sides, relative to the longitudinal direction of the tube 20 of the casing at an angle of , which extend into the casing, causing deep and fatal cuts to the animal rotating downward.

The blades 22 are located away from the exit of the casing to avoid injuries to the operating staff.

A module M7 is attached at the lower end of module M6 as sealing device. The design of module M7 described in the following can also be an integral part of module M6.

This sealing device has a pivotable lid 23 to which a floater 24 is attached. If the water level rises, the floater on the water rises and causes the lid 23 to rotate around the axis and lift, causing the exit of module M6 to close. Water cannot therefore penetrate the trap from below.

By contrast, if the water level is low, the lid 23 hangs down such that its inner surface 25 forms an impact area diagonal to the direction of drop (to the vertical). The invention can furthermore provide for this inner surface having at least one more blade 26 that it contacts with the animal when it drops.

This part positioned close to the effluent water is therefore coated with blood, serving as scented bait for other animals interested in the trap. Finally, the animal corpse falls into the effluent water of the sewer, bleeds out and attracts others of its species with a propensity for cannibalism that in their turn dispose of the corpse by consuming it, or it is washed away by the effluent water toward the sewage treatment plant and disposed of free from poison.

The modular trap described here is ready for operation again without a time delay.

In the event of heavy rain, flooding or high water, causing the sewer to be flooded completely, the invention can provide for a water-tight hood that is open at the bottom and that is placed at least over module M2. Rising water forms an air bubble in the hood that protects the trap from a further rise in water.

1. An animal rat or mouse trap comprising:
a catching device with a one-way segment;
a killing device in which a caught animal can be killed; and
an outlet area positioned downstream of the killing device through which the animal can be released from the animal trap.

2. The animal trap in accordance with claim 1, further comprising below the catching device:
an access device having a climbing element by which the animal enters the catching device.

3. The animal trap in accordance with claim 2, further comprising:
a guide device that has an at least partially enclosed space with a one-way entrance and an exit, the exit being constructed to guide a small animal directly from the exit to the access device.

4. The animal trap in accordance with claim 1, wherein the killing device has at least one electrically conductive electrode directly in the catching device downstream of or at a downstream end of the one-way segment.

5. The animal trap in accordance with claim 1, wherein the one-way segment of the catching device is provided with
a free wheel with a horizontal rotational axis, and that rotates freely toward the one-way segment and
a drop device is downstream of the catching device into which the animal falls from the free wheel toward the outlet area.

6. The animal trap in accordance with claim 5, wherein the drop device is formed by a vertical tube that connects the catching device and the outlet area or at least leads from the catching device toward the outlet area.

7. The animal trap in accordance with claim 6, wherein the tube has at least one projection on an inner wall surface winding spirally around a central tube axis and that has a triangular cross section perpendicular to a direction of elongation of the tube.

8. The animal trap in accordance with claim 6, wherein the killing device is below or in the drop device, the killing device is provided with knife blades diagonally to a direction of drop and to a longitudinal extension of the tube or with at least one comb-like electrode to which electrical alternating voltage has been applied.

9. The animal trap in accordance with claim 6, further comprising:
a packaging device downstream of the drop device or killing device in which an animal can be packaged in or with a plastic tube formed between two adhesive films.

10. The animal trap in accordance with claim 1, further comprising:
a hood or bell open at the bottom, in which at least the catching device is provided.

11. The animal trap system to form an animal trap in accordance with claim 1, wherein the different devices, are each formed by at least one modular element and the modular elements forming the different devices can be optionally combined with each other.

12. The animal trap system in accordance with claim 11, further comprising:
a module support plate on which the modular elements of the animal trap system can be fixed.

13. A method of operating an animal trap in accordance with claim 1, wherein a caught and killed or dying animal is conveyed automatically by the force of gravity to an outlet area of the trap, leaving the trap there.

14. The method in accordance with claim 13, wherein the animal is packaged in a packaging device of the animal trap arranged upstream of the outlet area in an air-tight manner or between two adhesive films.
